(19) United States
(12) Patent Application Publication
(10) Pub. No.: US 2022/0253800 A1
(43) Pub. Date: Aug. 11, 2022

(54) USING CUSTOM HYPERLINKS TO IMPLEMENT PRODUCT RETURNS IN A PRODUCT BASED MLM SYSTEM

(71) Applicant: KwikClick, LLC, Murray, UT (US)

(72) Inventor: Fred Cooper, Farmington, UT (US)

(21) Appl. No.: 17/588,863

(22) Filed: Jan. 31, 2022

Related U.S. Application Data
(60) Provisional application No. 63/143,316, filed on Jan. 29, 2021.

(51) Int. Cl. G06Q 10/08; G06Q 30/00

(52) U.S. Cl. CPC G06Q 10/0837; G06Q 10/0833; G06Q 30/0185

(57) ABSTRACT

The present disclosure is directed to methods for returning funds that were paid as commissions to users of a multi-level marketing (MLM) organization that were part of a product tree of related users. These funds may be recovered after a previously purchased product has been returned. This tree of related users may have been created by a first user purchasing a product and then promoting the sale of that product to a second user that purchased the product and that promoted sale of the product to a third user who also purchased the product. Commissions may have been paid to users within the product tree when users that they sponsored or users that their sponsors sponsored purchased the product. In an instance when a user returns a product, commissions paid based on the sale of that returned product will be returned using methods and apparatus consistent with the present disclosure.

### CROSS-REFERENCE TO RELATED APPLICATIONS

The present disclosure claims priority benefit of U.S. provisional patent application 63/143,316 filed on Jan. 29, 2021, the disclosure of which is incorporated herein by reference.

### BACKGROUND OF THE INVENTION

### Field of the Invention

The present disclosure is generally related to using custom hyperlinks in multi-level marketing systems and methods. More specifically the present disclosure is directed to using custom hyperlinks to provide product promotions, products, and commissions to related users in multi-level marketing systems.

### Description of the Related Art

A Multilevel marketing (MLM) commission payment system is a sales methodology used by some direct sales companies, which may be used to encourage existing distributors to recruit new distributors who are paid a percentage of their recruits' sales. The recruits are “downline” of the distributors. The term “downline” is used to describe sellers of products that have been sponsored by a sponsor (i.e. a sponsee of the sponsor) to sell products. The term “upline” is used to refer to sellers of products that sponsored a given sponsee. As such, sponsors are distributors that are upline from their sponsees and sponsees are distributors that are downline from their sponsors. Terminology used in the art refer to a recruit or a new person (i.e. distributor) sponsored by a sponsoring user is downline of the newly sponsored person, where the sponsoring user is “upline” of the newly sponsored person. Such persons or distributors also make money through direct sales of products to customers. Amway, which sells health, beauty, and home care products, is an example of a well-known direct sales company that uses multilevel marketing.

Multilevel marketing (MLM) has been found to be a legitimate business sales methodology if participants receive something of value for their participation in an MLM organization. Even though Amway has a pyramid like structure where sponsors may receive more benefits than new recruits, Amway has been judged to be a legitimate organization because all participants receive the benefit of purchasing products at a competitive price. One problem with some MLM organizations referred to as “pyramid schemes” where new recruits do not receive any benefit based on just joining the MLM organization. One characteristic of a MLM “pyramid scheme” versus a legitimate MLM organization is that in a “pyramid scheme” new recruits receive benefits based primarily from signing up other new participants. Thus, money received from the new recruits only pays people above them or at the top of the organization rather than new recruits or others who actually perform work (e.g. the selling of products). As such, a “pyramid scheme” is also characterized by paying sponsors rather than individuals that perform the work. This is why “pyramid schemes” are illegal. These “pyramid schemes” involve taking advantage of people by pretending to be engaged in legitimate multilevel or network marketing activities, when their greater focus is on recruitment rather than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Each MLM company dictates its own specific financial compensation (or commission) plan for the payout of any earnings to their respective distributors. Compensation may be in the form of commissions that require a participant to enter a contract, pledging exclusivity in participation to the MLM company paying the commissions. Currently MLMs require that users become members in order to distribute a product and these users have no way to allow anonymous buyers to be part of a member's multilevel marketing group from which commissions may be earned. Compensation plans of MLMs pay out to participants typically from two primary possible revenue streams. The first is paid out from commissions of sales made by the participants directly to their own retail customers. Retail customers are not tracked or known by the MLM company, therefore, MLM companies cannot substantiate either their existence or their sales volume individually or collectively. The second is paid out from commissions based upon the wholesale purchases made by other distributors below the participant who have recruited those other participants into the MLM; in the organizational hierarchy of MLMs, these participants are referred to as one's downline distributors.

MLM salespeople (distributors) are, therefore, expected to sell products directly to end-user retail consumers by means of relationship referrals and word of mouth marketing, but most importantly they are incentivized to recruit others to join the company's distribution chain as fellow salespeople so that these can become down line distributors.

Currently, no large financially successful MLM salesperson (distributor) can earn commissions of any significance or take full advantage of a commission compensation plan without personally recruiting others into their downline.

All MLM compensation companies permanently place new recruits in a tree structure for calculating commissions. Once placed, all sales made by that distributor from their personal purchases, or from new recruits they sponsor, generate commissions only for their sponsor and upline, regardless of all future products sold.

MLM companies offer goods or services offered specifically and exclusively by them. The large markups required for payment of commissions necessitate MLM companies to limit what products they can offer such that they will be financially indifferent regarding which product a distributor chooses to buy.

MLM companies currently have a “pay to play” requirement. Distributors are required to make monthly purchases, and/or meet downline group sales volumes to qualify for commissions. Thus the mode, median and average purchase size of a Distributor in MLMs is virtually equal to this minimum qualification requirement and no greater.

Distributors only qualify for commissions if they have purchased a minimum threshold of products offered exclusively by the MLM company as set forth by an MLM company's commission program rules.

Currently, in order to join an MLM organization, there is an initiation fee, which may be a barrier against those that just wish to refer a single product they like. Current multi-level marketing (MLM) systems do not take full advantage of the internet and how consumers can influence other consumers to make purchases. Also, current MLM systems do not incorporate incentivizing users of a multilevel marketing system by offering a dynamic commission tree. In addition, there is no current MLM system that utilizes the money or funds dedicated to discounts or coupons to be reincorporated into a multilevel marketing system to incentive consumers to make purchases and advertise the product that they purchased. Thus, there is a need to provide users a method to join an MLM for free, being simple to use and allow the MLM commissions provided to purchasers, provided by the sellers to allow the purchasers to market the seller's products.

Currently, a company that is not utilizing an MLM structure for paying commissions for sales, cannot introduce one without developing a compensation plan specific for their company, following the methodology outlined above, and thus requiring them to become and subsequently adhere to applicable MLM law.

Current MLM organizations also do not allow their members to create marketing materials that may help motivate other individuals to join the MLM organization or to motivate members to purchase products offered for sale by the MLM organization. What are needed are new types of systems and apparatus that allow MLM members create and share marketing materials. What are also needed is the ability to propagate sales of products without the need for participants to identify themselves.

Further, there is currently no systematic way for consumers to promote any brand of preference outside the MLM industry and be paid in an MLM commission methodology without subjecting themselves to a contractual signup, initiation fees, minimum recurring purchases sales, volume requirements, recruiting, exclusivity, and permanent tree placement (resulting in only upline distributors earning commissions).

Retail fraud accounts for more than $50 billion in losses. Return fraud is a type of retail fraud in which the item purchased is never intended to be kept, but rather is bought with the intent of returning, either for monetary reasons, such as coupon abuse, or for a form of renting a product for free, such as clothing or a tool. Much the same way coupon prices can be used against a retailer in the form of return fraud, the commissioning structure of a multi-level marketing system is vulnerable to abuse through various return fraud strategies. The impetus put upon MLM users to market their products, and the network they have built through the MLM system, creates a built in means to promote a fraud scheme instead of legitimate marketing. It is therefore desirable to have a means of connecting returns made at a retail or online store to multi-level marketing systems that pay out commissions to multiple individuals based on the purchase of the item being returned so as to prevent return and commission fraud by participants of the MLM system.

### SUMMARY OF THE PRESENTLY CLAIMED INVENTION

The presently claimed invention is directed to a method that may be implemented as a non-transitory computer readable medium where a processor executes instructions out of a memory to perform the method. In one embodiment, the method may include receiving information associated with a returned item that was sold by a vendor, identifying that the returned item is associated with a user of a multi-level marketing (MLM) organization, and identifying distributors of the MLM organization that purchased the item and that promoted sale of the item. This method may also include identifying commissions paid to identified distributors, retrieving funds equivalent to the paid commissions, and providing the retrieved funds for receipt by the vendor.

In a second embodiment, the method is implemented by a processor executing instructions out of the memory. Here again the method may include receiving information associated with a returned item that was sold by a vendor, identifying that the returned item is associated with a user of a multi-level marketing (MLM) organization, and identifying distributors of the MLM organization that purchased the item and that promoted sale of the item. This method may also include identifying commissions paid to identified distributors, retrieving funds equivalent to the paid commissions, and providing the retrieved funds for receipt by the vendor.

### BRIEF DESCRIPTIONS OF THE DRAWINGS

FIG. 1 illustrates different sets of computer systems that may be included in a computer networked multi-level marketing system.

FIG. 2 illustrates steps that may be performed at a computer when refunds associated with returned items purchased via a multilevel marketing organization are processed.

FIG. 3 illustrates steps that may be performed by a third party network computer of a vendor that works with a multi-level marketing organization to sell products.

FIG. 4 illustrates a computing system that may be used to implement an embodiment of the present invention.

### DETAILED DESCRIPTION

The present disclosure is directed to methods for returning funds that were paid as commissions to users of a multi-level marketing (MLM) organization that were part of a product tree of related users. These funds may be recovered after a previously purchased product has been returned. This tree of related users may have been created by a first user purchasing a product and then promoting the sale of that product to a second user that purchased the product and that promoted sale of the product to a third user who also purchased the product. Commissions may have been paid to users within the product tree when users that they sponsored or users that their sponsors sponsored purchased the product. In an instance when a user returns a product, commissions paid based on the sale of that returned product will be returned using methods and apparatus consistent with the present disclosure.

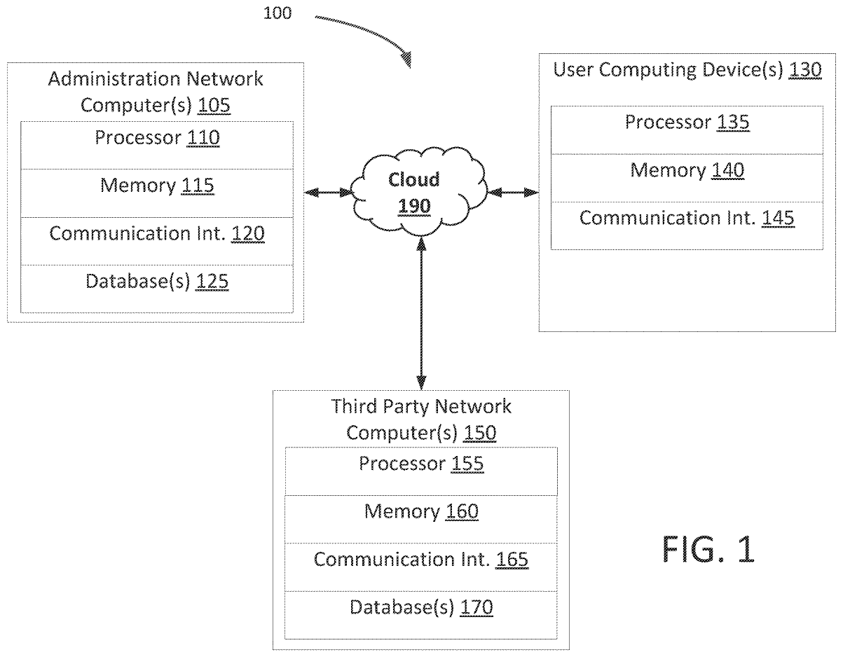

FIG. 1 illustrates different sets of computer systems that may be included in a computer networked multi-level marketing system. The various computers of FIG. 1 may implement functions consistent with a multilevel marketing (MLM) system 100 or MLM organization. FIG. 1 includes one or more administration computers 105, user computing devices 130, and third party network computers 150 that may communicate via the Internet or a cloud computing environment 190. Each of the different computers of FIG. 1 may include a processor, a memory, and a communication interface. Some of the computers illustrated in FIG. 1 include one or more databases where data relating to the operation of MLM system 100 may be stored. In operation each of the respective computers of FIG. 1 may execute instructions out a memory local to that processor and may communicate with other computers via a respective communication interface when products are added to or sold by members of a MLM organization.

Administration computer 105 includes processor 110, memory 115, communication interface 120, and database(s) 125. User computing device 130 includes processor 135, memory 140, and communication interface 145. Third (3^{rd}) party network computer 150 includes processor 155, memory 160, communication interface 165, and database(s) 170. A user of user device 130 may interact with a user interface (not illustrated) at user device 130 when accessing information stored at administration network computer 105 database(s) 125 or when accessing information stored at third party network computer 150 database(s) 150. Such interactions may allow a user to identify products that they can sell, identify new users, receive information relating to products they distribute as a member of an MLM organization, and that includes functionality for processing returns & refunds. Administration network computer 105 and 3^{rd} party network computer 150 may each execute instructions directed to processing refunds and may store data refund related data at respective databases 125 and 170 of FIG. 1. This refund process may include recovering commission fees paid to distributors associated with goods that were returned or to services that were cancelled.

Processor 110 of administration network computer 105 may execute instructions from one or more software modules when functions associated with the registration of new products and users, the sale or distribution of marketing materials are performed, payments of commissions, and processing refunds of fees when purchased products are returned. When software program code executed by processor 110 is organized as a set of multiple different software modules, those modules may include an administration network base module, a calculation module, a commission module, an advertising module, a vendor module, and a refund module. Computers 105 of an administration network may include or access one or more databases that may include an administration database, a compensation database, a hyperlink database, and a landing page database.

A user or distributor may refer to the non-salaried workforce selling the company's products or services, while the earnings of participants of an MLM organization may be associated with a pyramid-shaped or binary compensation commission system. A product may refer to an article or substance that is manufactured or refined for sale. A service may refer to a system supplying a public need such as transport, communications, or utilities such as electricity or water. A service may be an act of dealing with a customer in a store, restaurant, or hotel by taking their orders, showing, or selling them goods. Additionally, a service may be work that someone does or time that someone spends working for an organization, or a business that offers a particular type of help or work.

The administration network computer 105 may accept sellers (third parties), where a “single product tree” or “product tree” multi-level marketing method is formed, comprising the steps of, providing at least one product, providing an MLM system with a seller's commission structure, and providing at least one seller of a product with its associated commission structure. The term “single product tree” refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product that those other users were not previously associated with.

The administration network computer 105 may also provide a plurality of buyers/distributors, allow the at least one first seller to enroll a product to the MLM system, and allow at least a first buyer/distributor to purchase the product. Other functions that may be performed by the administration network computer 105 include allowing the at least the first buyer/distributor to advertise the product to other potential buyers/distributors and allowing at least a second buyer/distributor to buy the advertised product. Here the seller may set a commission structure for a product, may enroll the product into the MLM system, may allow the first, second and so on purchasers/distributors to purchase and advertise the product.

Instructions of an administration network product enrollment software module may allow users to create a first referral code that may be stored at a database 125 of FIG. 1. Such a database may be referred to as an administration network hyperlink database. Instructions of an administration network hyperlink creating software module may allow users to create a hyperlink by combining the user specific referral code, discussed above, with information of what may be referred to as a “landing page.” Such a “landing page” may be webpage hosted at third party network computer 150 and that landing page may include information associated with purchasing a product or purchasing a product at discount rate. This landing page data may be accessed by or copied to an administration network computer 105. In certain instances, a discount may be applied based on a code that is provided to the third party network computer 150 via a specific landing webpage. A prospective buyer may be allowed to enter a code via a user interface associated with the landing webpage or a code may be received automatically after a user selects (or clicks on) a referral hyperlink at their user device. Alternatively, or additionally, such landing pages or landing webpages may be hosted by administration network computer 105.

Functionality of a landing webpage may be invoked after a referral or set of marketing materials are displayed on a display of a user device. These materials may include a universal resource locator (URL) or an embedded URL that when selected results in a browser of the user device to receive content of the landing webpage. Here, a code may be entered by a user to gain a discount or that code may be automatically provided to the landing webpage and the user device may be sent a discount offer to purchase a product. This offer may be displayed on a display of the user device and a user by interacting with their user device may order the product. Once purchased and potentially after the user receives the ordered product, commissions may be paid to upline members of an MLM organization that are associated with the user that purchased the product. Marketing materials provided to users via their user devices may include various types of media, such as photos, videos, text, sounds, haptics, online product descriptions, etc. for enhanced marketing.

Once products have been enrolled with a commission structure, the administration network computer 105 may allow the purchasers/distributors to receive a commission based upon the seller's product commission structure. A distributor may refer to the non-salaried workforce selling the company's products or services. Here the earnings of the participants may be derived from a pyramid-shaped or binary compensation commission system. The term product may refer to articles or substances manufactured or refined for sale. Product may refer to an individual product, a line of products such as unique brand and model of drill, or a group of products such as all power tools. A service may refer to a system supplying a public need such as transport, communications, or utilities such as electricity or water.

A service may also be an act of dealing with a customer in a store, restaurant, or hotel by taking their orders, showing, or selling them goods. Additionally, a service may be work that performed by a person of may related to an amount of time that someone spends working for an organization, or a business that offers a particular type of help or work. The system 100 of FIG. 1 may distribute commissions according to an MLM tree or commission tree that is a payment structure in which commissions are given out at different percentages at different fs of the MLM tree, for example. In such a system distributors (users) that perform the sale or that are at a level that is “closer” to the distributor that performed the sale may receive larger commissions than distributors that are “farther” from the sale.

In another example, a first MLM distributor that performs a sale may receive a higher percentage than a second MLM distributor that sponsored the first MLM distributor, and a third MLM distributor that signed up the second MLM distributor may receive a lower commission than the commission received by the second distributor for the sale. Distributors in an MLM tree may be referred as “downline” or “upline” distributors depending on where different users rank on the MLM tree. For example, a first user that sponsors a second user is “upline” from the second user and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. End of life of MLM tree may refer to the end of the MLM tree in which the commission tree may be restructured or eliminated. For example, further participants in the MLM may not receive a commission, the commission tree may “start up” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 105 may perform data security functions as well as functions associated with operation of an MLM algorithm that may calculate user compensation. Administration network computer 105 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline participants.

A set of commission program instructions may cause a computer processor 110 at the administration network computer 105 to continuously poll for user data (e.g., data of a user who may be a product purchaser or product distributor) from another processor executing a set of discount program instructions at a third party network computer 150. Once the processor 110 of the administration network computer 105 receives the user data, commissions may be calculated using the commission program instructions. These commissions may be calculated based on data stored in an administration network compensation database. Downline and upline commissions for the other users (product purchasers/distributors) within the MLM tree may be paid. The administration network compensation database may be included within the administration database 125 of FIG. 1 or it may be a separate database accessible by the administration network computer 105. Alternatively, instead of the administration network computer 105 polling a third party network computer 150, the third party network computer 150 may send the user data to the administration network computer 105 after a sale has been made.

An upline may refer to the MLM distributors that recruits work for as salespeople to sell the products or services. A downline may refer to the recruits the MLM distributors are able to secure as participants in the MLM system. Downline MLM trees may go across country boundaries and commissions may be paid out for an MLM tree even though the participants in the MLM tree may not reside in the same country. The commissions may be calculated for the appropriate exchange rate to ensure participants are paid in their residing countries currency in the correct amount.

A processor executing the commission program instructions may continuously poll for user data from the third party network computer 150. The administration network computer 105 may then receive the user data from the third party network computer 150. Then the administration network computer 105 may determine whether the user entered a code. If the user did enter a code, the processor at the administration network computer 105 may extract the code and then access the administration network compensation database to identify one or more different spheres of influence or potential product purchasers/distributors levels. Such a code may have been received from user device 130 based on user inputs. A sphere of influence for a given product may be associated with a chain of upline and downline distributors that sold a particular product, where each downline user may have been sponsored to sell the product by an upline user.

The processor 110 at the administration network computer 105 may also associate a code for each of the different spheres of influence. The administration network computer 105 may then extract a corresponding commission for the code that was retrieved from in the administration network compensation database. The administration network computer 105 may then send the commission to the user (purchaser/distributor) via communication interface 120 and the Internet or cloud 190. The administration network computer 105 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 105 may also compare the extracted code to data stored at an administration network code database that may store a list of users and code sent to followers. This administration network code database may be the same database as the administration database 125 of FIG. 1 or it may be another database accessible by the administration network computer 105. The administration network computer 105 may extract a user ID and sphere of influence or potential purchasers/distributors by using the extracted code.

The administration network computer 105 may then compare the extracted sphere of influence or potential purchaser/distributor to data stored at the administration network compensation database. The administration network computer 105 may then use the extracted sphere of influence data to extract a corresponding commission from the administration network compensation database. The administration network computer 105 may then send the commission to an upline user. If the user did not enter a code, the administration network computer 105 may then initiate a set of administration network advertising program instructions.

The administration database 125 may store data received from various third parties (various sellers) that are part of a set of MLM trees. This data may contain an item ID, description of the item, an original cost of the item, a discount for the item, a cost of the item with the discount, a compensation plan decay rate, and a link to the item. An advertising link may refer to a link that directs a consumer to a product, service or good.

TABLE 1
Administration Database Data

| Third Party | Home Depot | Home Depot | Furniture Store |
|---|---|---|---|
| ID | 654123 | 789654 | 123789 |
| Item | Drill | Table Saw | Couch |
| Original Cost | $59.00 | $119.00 | $999.00 |
| Discount | 15% | 10% | 10% |
| Discount Cost | $50.15 | $107.10 | $899.10 |
| Compensation | 50% | 50% | 30% |
| Decay Rate | | | |
| Link | HDDrill654123 | HDTSaw789654 | FSC123789 |

Table 1 table displays data that may be stored at the administration database 125 of FIG. 1. When the administration network computer 105 receives item data from third party network computer 150 it creates a link for the item, stores the received data in the administration network administration database 125, and sends the created link back to the third party network computer 150. The administration network database 125 may be used to store data collected from various third parties that enrolled in the multi-level marketing system 100 of FIG. 1. The administration network database 125 may store the name of the third party, the ID for an item, a description of the item, the original cost of the item, the discount provided by the third party, the cost of the item with the discount, the compensation decay rate or how the downline commissions are calculated, and the link to the item. This compensation data may not only be used to pay commissions to users, they may be used to identify commissions that should be recovered when a previously purchased product is returned.

The administration database 125 may store data that the administration network computer 105 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

As mentioned above user device 130 may include a memory 140, a processor 135, and a communication interface 145. The processor 135 of user device 130 may execute instructions out of the memory 140 when a user of user device 130 registers as a member of an MLM organization. Other tasks that a user may perform on user device 130 could include, identifying or connecting with other user devices (e.g. follower user devices), preparing advertisement information to share with follower user devices, receiving advertisement information prepared by other users, accessing product promotions at the third party network computer 150, purchasing products based on offerings received from the third party network computer 150, and issuing refunds associated with returned products. Each of the tasks performed by user device 130 may include sending and receiving communications with the administration network computer 105, the third party network computer 150, or other user devices. Promotions prepared at a particular user device may be shared with other user device via administration network computer 105, third party network computer 150, a social media network computer, or directly from one user device to another. User devices may also be required to download and install an application program from an application store, such as the “Apple App store” as part of a process for registering as a member of an MLM organization.

The user device communication interface 145 of FIG. 1 may send and receive data via a communication network 190 which may be a wired and/or a wireless network. User device(s) 130 may be devices such as a laptop computer, a smartphone, a tablet, a desktop computer, or smart speaker, for example.

As discussed above the third party network computer 150 of FIG. 1 may include a computer processor 155, a memory 160, and communication interface 165. This third party network computer 150 may be controlled by various third parties, such as retail stores (stores that sell product consumables, services, franchises, service networks, large box stores) or e-commerce sites that allow e-commerce sales. Such e-commerce sites may include an e-commerce shopping cart, that offer items to users at a discount, such as a product discount, in order to use the MLM system of FIG. 1. A franchise may refer to an authorization granted by a government or company to an individual or group enabling them to carry out specified commercial activities, e.g., providing a broadcasting service, or acting as an agent for a company's products. Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduced price or something being sold at a price lower than that item is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third party network communication interface 165 of FIG. 1 may send data and receive via a communication network 190 which may be a wired and/or a wireless network.

The third party network discount program instructions may be executed by a computer processor 155 after being initiated by a set of third party network base program instructions. These instructions may cause the processor 155 at the third party network computer 150 to prompt a user device for a discount code and to compare a received code to data stored at a third party network third party database 170. When a code received from a user matches data stored at the database 170, a discount for the selected item may be applied and an order for a product may be processed.

The communications network 190 of FIG. 1 may be the Internet or a cloud computing network. This communication network or any of the communication network interfaces 150 or 170 discussed herein may be a wired and/or a wireless network. Such a communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

Table 2 illustrates a set of data referred to herein as “landing page” data. This data cross-references an item identifier (ID) with an item name, a vendor (e.g. a 3^{rd} party vendor), and a universal resource locator that points to a website of the vendor where an item (e.g. a product or service) is offered for sale. This landing page data may be stored in a landing page database or may be stored as landing page data stored at a database that stores various different types of data accessible by an administration network computer, such as database 125 of administration computer 105 of FIG. 1 or this data may be stored at a database of a 3^{rd} party vendor accessibly by the administration network computer. This landing page data may be accessible by software modules executable at an administration computer when the administration computer performs tasks of selling products and services offered via participation in an MLM organization. Table 2 identifies that item id 654123 is associated with an item named “drill” product sold by a 3^{rd} party vendor Home Depot at URL https://www.homedepot.com/ . . . . Table 2 also cross-references item ID 789654 with a “table saw” product also offered for sale via a Home Depot URL; cross-references item ID of 123789 with a “couch” sold by vendor “Furniture Store” at URL https://www.bobsfurniture.com/ . . . ; and cross-references item ID 456812 with “cold medicine” product offered by a “pharmacy” at URL https://www.vons.com/ . . . .

TABLE 2
Landing Page Data

| | | 3rd Party | |
|---|---|---|---|
| Item Id | Item Name | Vendor | Landing Page URL |
| 654123 | Drill | Home Depot | https://www.homedepot.com/ . . . |
| 789654 | Table Saw | Home Depot | https://www.homedepot.com/ . . . |
| 123789 | Couch | Furniture Store | https://www.bobsfurniture.com /. . . |
| 456812 | Cold | Pharmacy | https://www.vons.com/ . . . |
| | Medicine | | |

Functions that track activity of users that select a generated hyperlink may also be tracked by a computer such as administration computer 105 of FIG. 1 using this hyperlink database data. Here, a program code associated with such functions may be used to track user activity. A user device that has received a selection to view a webpage identified by a modified URL (a generated hyperlink) may be sent a cookie that may be attached to a web browser operational at the user device. This process may include retrieving a cookie or other data from a user device. This cookie or other data may be retrieved by an administration computer before the administration computer redirects the web browser of the user device to a computer of a 3^{rd} party that offers items for sale. This cookie or data may then be used to track actions performed by the user device. Information that associates this cookie with the user device and with the 3^{rd} party computer or item may be stored at a database of the administration computer. At this point in time, the administration computer would have received information regarding the fact that a particular user device initiated an access to view a particular product offering. Data collected by the administration computer may include the cookie, a code associated with the user device or with a user, a parent code associated with another user or other user device, and information associated with the product offered at the 3^{rd} party website.

Table 3 illustrates an exemplary set of data that may be used to track the activities of products sold by various individual distributors. A first row of table 3 includes a series of column headers that are used to cross reference item identifying numbers (IDs), product names, parent codes, child codes, user identifiers (IDs), and specific generated hyperlinks (URLs). Note that the rows 2-4 of table 3 include information that identifies sales of a type of cold medicine. First of all, a user with user ID “Kwik” purchased cold medicine with item ID of 456812. This first user is associated with child code ai9ufy6HE4. Since this first user was a first user of a new user product tree selling cold medication with item ID 456812, no parent code is associated with this purchase. The hyperlink in the second row of table 3 identifies an administration computer “Kwik,” a third party seller/store of “Vons,” product ID 456812, and child code ai9ufy6HE4.

The hyperlink in the third row of table 3 may have been provided to a user device belonging to a prospective buyer of the cold medicine assigned item ID 456812. The user device of this prospective buyer may have received marketing materials prepared by the user assigned with user ID “Kwik.” Later when this prospective buyer purchases the cold medicine, this prospective buyer may be assigned user ID HF4875 and child code LmPwRESpH. Since this prospective buyer in now an actual buyer, they may be considered a new member of a multilevel marketing tree associated with parent ID ai9Ufy6He4 (that belongs to user ID “Kwik”). Based on this chain of events, a person with user ID “Kwik” may receive a commission based on the sale of the cold medicine to a person with user ID HF4875. Methods consistent with the present disclosure may also recover commissions paid to users when a previously product is returned by identifying relationships between users after reviewing data stored in table 3.

The data stored in the third row of table 3 is a record of a chain of sales as this third row of data indicates that the person assigned user ID HF4875 purchased cold medicine 456812 based on a referral made using code ai9ufy6HE4. The parent code included in this third row being the same as the child code of the second row of table 3 may be used to identify which users should receive commissions for sales that they sponsored. Note also that the hyperlink included in the third row of table 3 identifies the “Kwik” administration computer, the “Vons” third party seller, the cold medicine product name, the cold medicine product ID, and the child code LMPwRESpH. In an instance when this hyperlink is used to sell the cold medicine with product ID 456812 to another new user, users associated with user ID HF4875 and user ID Kwik may each receive commissions based on this new sale.

Table 3 also tracks the sale of other products associated with other item IDs, parent codes, child codes, user IDs, and hyperlinks. Parsing of this information may be done to identify particular users that have or that should receive commissions. Note that user with code sZa2q6jDuo is credited with selling couch 123789 to buyers with child codes IvOdgpFsJ5 and ogV1LAwT50. Note also that the buyer with child code IvOdgpFsJ5 does not have a user ID based on the not applicable/available (N/A) identifier being listed as a user ID.

Note also that user with user ID Kwik purchased table saw 789654, that a buyer with child code g05HfVMC purchased this same type of table saw, and that the buyer with child code g05HfVMC is also associated with selling that same type of table saw to a user with user ID VY0093 and child code z4jjna7t3c.

Each of the upline distributors/users may receive commissions identified based on parsing of respective child codes, related parent codes, and item identifier codes. For example, a user assigned user ID Kwik may receive commissions for the cold medicine purchased by users associated with both user ID HF4875 and YD9483 and a user associated with user ID HF4875 may receive a commission based on the user associated with user ID YD9483 purchasing the cold medication. Here again, commissions further from the actual purchase may be reduced or paid out based on a commission schedule.

TABLE 3
Administration Network Hyperlink/Tracking Database Data

| | Product | | | | |
|---|---|---|---|---|---|
| Item ID | Name | Parent Code | Child Code | User ID | Hyperlink |
| 456812 | Cold | N/A | ai9ufy6HE4 | Kwik | https://kwik.vons.com/pharmacy/ |
| | Medicine | | | | coldmedicine/?kwikcode=456812ai9ufy6HE4 |
| 456812 | Cold | ai9ufy6He4 | LmPwRESpH | HF4875 | https://kwik.vons.com/pharmacy/ |
| | Medicine | | | | coldmedicine/?kwikcode=456812LmPwRESpH |
| 456812 | Cold | LmPwRmESpH | H23s123Dxx | YD9483 | https://kwik.vons.com/pharmacy/ |
| | Medicine | | | | coldmedicine/?kwikcode=456812H23s123Dxx |
| 123759 | Couch | N/A | sZa2q6jDuo | Kwik | https://kwik.bobsfurniture.com/.../?kwikcode= |
| | | | | | 123789sZa2q6Duo |
| 123759 | Couch | sZa2q6jDuo | IvOdgpFsJ5 | N/A | https://kwik.bobsfurniture.com/.../?kwikcode= |
| | | | | | 123798ivOdgpFsj5 |
| 123759 | Couch | sZa2q6jDuo | ogV1LAwT50 | MF1192 | https://kwik.bobsfurniture.com/.../?kwikcode= |
| | | | | | 123789ogV1lawT50 |
| 654123 | Drill | N/A | eyySAh0ijh | Kwik | https://kwik.homedepot.com/.../?kwikcode= |
| | | | | | 654123eyySAh0ijh |
| 654123 | Drill | eyySAh0ijh | D5Tn6nQq70 | HG9873 | https://kwik.homedepot.com/.../?kwikcode= |
| | | | | | 654123D5Tn6nQq70 |
| 654123 | Drill | N/A | EejbIOK3Uu | JD4483 | https://kwik.homedepot.com/.../?kwikcode= |
| | | | | | 654123EejbIOK3Uu |
| 739634 | Table Saw | N/A | WLW2AaMQ6Q | Kwik | https://kwik.homedepot.com/.../?kwikcode= |
| | | | | | 789654WLW2AaMQ6Q |
| 739634 | Table Saw | WLWZAaM6Q | g05HfVMC | N/A | https://kwik.homedepot.com/.../?kwikcode= |
| | | | | | 789654g05HfVMC |
| 739634 | Table Saw | g05HfVMC | z4jjna7t3c | VY0093 | https://kwik.homedepot.com/.../?kwikcode= |
| | | | | | 789654z4jjna7t3c |

Table 4 illustrates data that may be stored in a purchase database that may reside at a third party computer network. The data of table 4 may be maintained by the third (3^{rd}) party computer 150 of FIG. 1 and this data may be stored in database 170 of FIG. 1. The data of table 4 shows several different purchases of a drill product identify by product identifiers (IDs) 654123, shows transaction IDs of 12345, list prices of $59.00, paid prices of $49.00, discount codes (when used), sales dates, return status, and return data. Note that the data of table 4 illustrates that a product purchased on Jan. 20, 2002 was returned on Jan. 10, 2020.

When a product is returned, a transaction ID associated with product being returned maybe identified by a 3^{rd} party network computer. This process may include identifying whether, a discount code is associated with the transaction. In instances when a discount code is associated with the transaction ID, that ID may be identified or an actual price that was paid to purchase the product may be identified. The data of table 4 shows that a discount code 654123-S012 is associated with the transaction ID 12346 for product ID 654123. After this, a prompt or communication may be sent to an administration network computer informing that computer of the return. At this time the price paid by the person to purchase the product may be returned to the person and the administration network computer may initiate a process of debiting distributors of commissions that were previously received by those distributors. In instances when no discount code is associated with the transaction ID, the purchase price may be refunded to the customer according to a return policy of a 3rd party vendor. This may also result in the process of debiting distributors of commissions that were previously received by those distributors.

In some embodiments, there may be a product consumables software module used by the 3rd party network computer to determine whether the product, service, or item being returned can be recirculated by being placed back into an inventory of goods for sale at a 3^{rd} party vendor. For example, when the returned product was food or an item that included an expiration date, the product consumables software module may determine the remaining “shelf” life or remaining life of the item by using the expiration data along with the returned date to determine if the item or product could be returned to the inventory. Also, when an item or product was used and returned, the product consumables module may determine a lower cost to return the item to the inventory. For example, when the returned item was tires for a vehicle, the product consumables module could determine the price by using the product data (e.g. original thread on the tires) and comparing it to the state of the product when it was returned (e.g. the current thread on the tires) to determine an appropriate cost to place the item back into the inventory. At this point in time a database at the 3rd party network computer may be updated to reflect that the product was returned and the date of the return.

TABLE 4
Third Party Sales and Return Data

| Product | | Transaction | List | Paid | Discount | Sale | Return | Return |
|---|---|---|---|---|---|---|---|---|
| ID | Item | ID | Price | Price | Code | Date | Status | Date |
| 654123 | Drill | 12345 | $59.00 | $49.00 | N/A | Jan. 1, 2020 | N | N/A |
| 654123 | Drill | 12345 | $59.00 | $49.00 | 654123- | Jan. 2, 2020 | Y | Jan. 10, 2020 |
| | | | | | SOI2 | | | |
| 654123 | Drill | 12345 | $59.00 | $49.00 | 654123- | Jan. 3, 2020 | N | N/A |
| | | | | | SOI3 | | | |

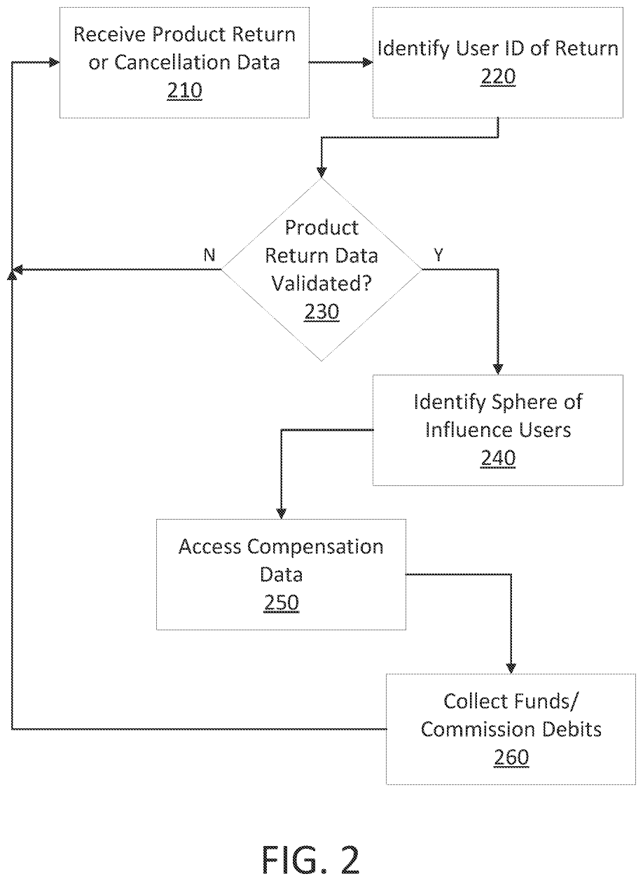

FIG. 2 illustrates steps that may be performed at a computer when refunds associated with returned items purchased via a multilevel marketing organization are processed. The steps of FIG. 2 may be performed at an administration network computer after a purchased product has been returned or after a service has been cancelled. FIG. 2 begins with step 210 where product return information or order cancellation data is received. This data may include any or all information associated with a purchase. For example, this data may include data from table 4, such as an item/product identifier (ID), a transaction ID, a discount code, a return status, and a return date. Data received in step 210 may include or may be associated with any of the data illustrated in any of tables 1-4. Because of this the data received by the administration computer may allow that computer to identify returned products, compensation rates, compensation decay rates, vendors associated with a return or cancellation, URL associated with a sale (when relevant), and distributors to which compensation was paid for a returned product or cancelled service.

After step 210 program flow may move to step 220 where a user ID associated with the return may be identified. Step 220 may also identify an item/product ID, a child code, and possibly a parent code associated with the return. Program flow may then move to determination step 230 that may validate the return product data. This validation process may include comparing information received from a 3^{rd} party computer regarding a returned item with data stored at a database of an administration computer that is used to track user purchases. When information received regarding a returned item matches the tracking data stored at the database, the received information regarding the return may be considered as being valid return information. As such, this validation may include comparing received return data to stored tracking data.

When determination step 230 cannot validate the return data, program flow may move back to step 210 where additional product return or cancellation data may be received. While not illustrated in FIG. 2, a message may be sent to a 3^{rd} party computer from which the return or cancellation data was received indicating that the return information could not be validated by the administration computer.

While not illustrated in FIG. 2, program code instructions of an administration network computer may identify a user that frequently return products and this user may be assigned a risk associated with frequent product returns. A user that returns more than a threshold number of products or percentage of products over a given time frame may be blocked from becoming or may be removed as being a product distributor. For example, if a user returns 80% of products purchased over a two-week period, they may be blocked from being a distributor. In some instances, users may be prompted or sent messages to identify reasons for a return. In an instance when a return base because of a safety hazard, recall, faulty piece, broken part(s), etc., instructions of a return notification software module may be used to determine if the reason for a product would warrant notifying the upline and downline buyers/distributors of the reason for the return. Such warning messages may not be limited to related distributors, yet may be sent to user devices of all users that purchased a potentially defective or dangerous product via the MLM organization. For example, if a buyer/distributor purchased a children's toy that was not identified as including a potential choking hazard for a child and the children's toy was returned because of the potential of choking hazard, the return notification module could notify all the other buyers/distributors of the potential choking hazard.

When determination step 230 successfully validates the product return data, program flow may move to step 240, where additional reference codes (e.g. child or parent codes) associated with the returned product may be identified. The child and parent codes identified in steps 220 or 240 may be used to identify user distributors within a sphere of influence associated with the returned product. Here again these distributors may be all part of the same product tree, where each respective distributor that purchased the product referred the product to another distributor that also purchased the product.

After step 240, step 250 may access compensation data to identify distributors that received commissions based on the sale of the returned product. Then in step 260 of FIG. 2 funds associated with those commissions may be collected by the administration computer. Step 260 may include debiting an account associated with the various different distributors that received commissions based on the sale of the returned product. Step 260 may also authorize the return funds previously paid as commissions to distributors back to the 3^{rd} party network computer.

For example, since product ID 654123 is associated with the drill that was returned. The commissions that correspond to each sphere of influence for the returned product may be retrieved from the administration network compensation database. In an instance when the product is associated with a 50% commission decay rate and the commission for the product 654123, for a first distributor participant is $3.33, a commission for a second distributor (a second sphere of influence level) would be $1.66, and a commission for a third distributor (a third sphere of influence level) it would be $0.83. Here, the identified commission values may be combined with the user ID's and sphere of influence associated with the returned product so as to accurately debit the accounts associated with each respective distributor that received commissions in the same manner that commissions were previously paid. This may be done with a bank account or credit card linked to the user to which commissions are credited and/or debited. In alternate embodiments, the commissions may be credited and billed as payments made to and due from the user to the admin network. In still further embodiments, a set of rules or artificial intelligence could be applied to monitor return patterns and take punitive action against users that abuse the return system through systematic and/or frequent returns. Once the previously paid commissions are debited from the user distributors they may be returned to the 3rd party network return computer. In the instance reviewed above, total commissions returned to would be $5.82.

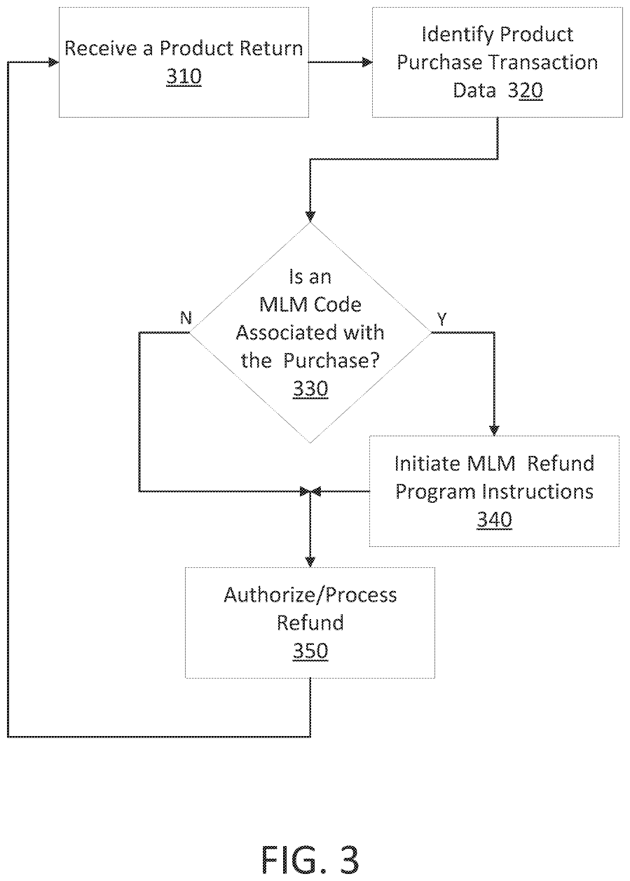

FIG. 3 illustrates steps that may be performed by a third party network computer of a vendor that works with a multi-level marketing organization to sell products. The steps of FIG. 3 may alternative be performed by an administration computer when the administration computer performs vendor related functions. Step 310 of FIG. 3 is a step where a returned product is received. Next in step 320, product transaction data may be identified. This product transaction data may include a transaction identifier (ID) and possibly other information that may include an item/product identifier (ID), a discount code, a return status, and a return date. Data received in step 320 may include or may be associated with any of the data illustrated in tables 1-4. Any of this data may be sent to an administration computer to allow that administration computer to identify returned products, compensation rates, compensation decay rates, vendors associated with a return or cancellation, URL associated with a sale (when relevant), and distributors to which compensation was paid for a returned product or cancelled service.

Program flow may then move to determination step 330 that identifies whether the returned product is associated with a multi-level marketing (MLM) code (such as a discount code, a child code, or parent code discussed above) or is associated with a sale of an MLM organization. When no, program flow may move to step 350 where a refund may be authorized and processed. When determination step 330 identifies that the product purchase was related to MLM sale or code, program flow may move to step 340 where MLM refund program instructions may be initiated. Step 340 may include sending product return cancellation data to the administration computer. As such the 3^{rd} party network computer may provide the data received by the administration computer in step 210 of FIG. 2. Step 340 may also include receiving funds previously paid as sale commissions from the administration computer or may receive message data from the administration computer indicating that the administration computer could not validate this purchase. After step 340, program flow may move to step 350 where refunds may be authorized and processed such that the purchaser that returned the product could receive their money back.

An MLM code used to identify that a product is associated with a purchase of an MLM organization may be a discount code of table 4 or may be a child or parent code of table 3 or another code specifically associated with an MLM organization.

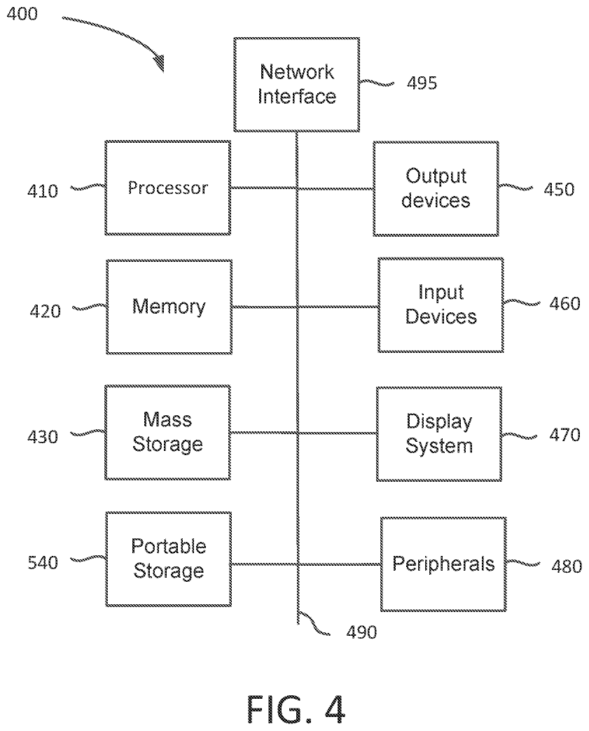

FIG. 4 illustrates a computing system that may be used to implement an embodiment of the present invention. The computing system 400 of FIG. 4 includes one or more processors 410 and main memory 420. Main memory 420 stores, in part, instructions and data for execution by processor 410. Main memory 420 can store the executable code when in operation. The system 400 of FIG. 4 further includes a mass storage device 430, portable storage medium drive(s) 440, output devices 450, user input devices 460, a graphics display 450, peripheral devices 480, and network interface 495.

The components shown in FIG. 4 are depicted as being connected via a single bus 490. However, the components may be connected through one or more data transport means. For example, processor unit 410 and main memory 420 may be connected via a local microprocessor bus, and the mass storage device 430, peripheral device(s) 480, portable storage device 440, and display system 450 may be connected via one or more input/output (I/O) buses.

Mass storage device 430, which may be implemented with a magnetic disk drive—an optical disk drive—or FLASH memory, is a non-volatile storage device for storing data and instructions for use by processor unit 410. Mass storage device 430 can store the system software for implementing embodiments of the present invention for purposes of loading that software into main memory 420.

Portable storage device 440 operates in conjunction with a portable non-volatile storage medium, such as a FLASH memory, compact disk or Digital video disc, to input and output data and code to and from the computer system 400 of FIG. 4. The system software for implementing embodiments of the present invention may be stored on such a portable medium and input to the computer system 400 via the portable storage device 440.

Input devices 460 provide a portion of a user interface. Input devices 460 may include an alpha-numeric keypad, such as a keyboard, for inputting alpha-numeric and other information, or a pointing device, such as a mouse, a trackball, stylus, or cursor direction keys. Additionally, the system 400 as shown in FIG. 4 includes output devices 450. Examples of suitable output devices include speakers, printers, network interfaces, and monitors.

Display system 450 may include a liquid crystal display (LCD), a plasma display, an organic light-emitting diode (OLED) display, an electronic ink display, a projector-based display, a holographic display, or another suitable display device. Display system 450 receives textual and graphical information and processes the information for output to the display device. The display system 450 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 480 may include any type of computer support device to add additional functionality to the computer system. For example, peripheral device(s) 480 may include a modem or a router.

Network interface 495 may include any form of computer interface of a computer, whether that be a wired network or a wireless interface. As such, network interface 495 may be an Ethernet network interface, a BlueTooth™ wireless interface, an 802.11 interface, or a cellular phone interface.

The components contained in the computer system 400 of FIG. 4 are those typically found in computer systems that may be suitable for use with embodiments of the present invention and are intended to represent a broad category of such computer components that are well known in the art. Thus, the computer system 400 of FIG. 4 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 400 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The functions performed in the processes and methods which may be implemented in differing order. Furthermore, the outlined steps and operations are only provided as examples, and some of the steps and operations which may be optional, combined into fewer steps and operations, or expanded into additional steps and operations without detracting from the essence of the disclosed embodiments.

What is claimed is:

1. A method for using custom hyperlinks to track refunds, the method comprising:
storing information regarding a plurality of custom hyperlinks, each hyperlink corresponding to a product and a set of codes corresponding to a set of distributors;
receiving information regarding a returned item associated with one of the custom hyperlinks;
identifying that the returned item is associated with a purchase made by a user of a multi-level marketing (MLM) organization based on the codes in the stored information identifying the set of distributors associated with the returned item, and wherein the user is among the set of distributors; and
implementing a refund process, wherein implementing the refund process includes reversing one or more commissions paid to each of the identified distributors of the set of distributors associated with the codes in the stored information.

2. The method of claim 1, further comprising identifying a user identifier (ID) assigned to the user of the MLM organization that returned the item.

3. The method of claim 1, further comprising:
identifying a price paid to purchase the returned item; and
identifying a commission schedule associated with the commissions paid to each of the identified distributors, wherein the commissions paid to each of the identified distributors are a function of the commission schedule.

4. The method of claim 3, further comprising:
identifying a first commission paid to a first distributor of the identified distributors according to the commission schedule;
identifying a commission decay rate of the commission schedule; and
performing a calculation to identify a second commission paid to a second distributor of the identified distributors, wherein the second commission is a function of the first commission and the commission decay rate.

5. The method of claim 4, further comprising performing a calculation to identify the first commission paid to the first distributor, wherein the first commission corresponds to a percentage of the price paid to purchase the item.

6. The method of claim 1, further comprising:
comparing the received information associated with the item with stored tracking data; and
validating that the item was purchased by the user based on the comparison of the received information with the tracking data.

7. The method of claim 1, further comprising identifying a first code associated with a first distributor of the identified distributors that promoted the item to the user, the identification based on an evaluation of stored tracking data.

8. The method of claim 7, further comprising identifying a second code associated with a second distributor that the promoted the item to the first distributor.

9. The method of claim 8, further comprising identifying a third code associated with a third distributor that promoted the item to the second distributor.

10. The method of claim 1, further comprising:
identifying a number of items purchased by the user;
identifying a number of items returned by the user;
identifying that the number of items purchased by the user divided by the number of items returned by the user corresponds to a percentage that at least meets a threshold level; and
blocking the user from purchasing items associated with the MLM organization based on the percentage at least meeting the threshold level.

11. A non-transitory computer-readable storage medium having embodied thereon a program executable by a processor for implementing a method for providing refunds of commissions, the method comprising:
storing information regarding a plurality of custom hyperlinks, each hyperlink corresponding to a product and a set of codes corresponding to a set of distributors;
receiving information regarding a returned item associated with one of the custom hyperlinks;
identifying that the returned item is associated with a purchase made by a user of a multi-level marketing (MLM) organization based on the codes in the stored information identifying the set of distributors associated with the returned item, and wherein the user is among the set of distributors; and
implementing a refund process, wherein implementing the refund process includes reversing one or more commissions paid to each of the identified distributors of the set of distributors associated with the codes in the stored information.

12. The non-transitory computer-readable storage medium of claim 11, further comprising instructions executable to identify a user identifier (ID) assigned to the user of the MLM organization that returned the item.

13. The non-transitory computer-readable storage medium of claim 11, further comprising instructions executable to:
identify a price paid to purchase the returned item; and
identify a commission schedule associated with the commissions paid to each of the identified distributors, wherein the commissions paid to each of the identified distributors are a function of the commission schedule.

14. The non-transitory computer-readable storage medium of claim 13, further comprising instructions executable to:
identify a first commission paid to a first distributor of the identified distributors according to the commission schedule;
identify a commission decay rate of the commission schedule; and
perform a calculation to identify a second commission paid to a second distributor of the identified distributors, wherein the second commission is a function of the first commission and the commission decay rate.

15. The non-transitory computer-readable storage medium of claim 14, further comprising instructions executable to perform a calculation to identify the first commission paid to the first distributor, wherein the first commission corresponds to a percentage of the price paid to purchase the item.

16. The non-transitory computer-readable storage medium of claim 11, further comprising instructions executable to:
compare the received information associated with the item with stored tracking data; and
validate that the item was purchased by the user based on the comparison of the received information with the tracking data.

17. The non-transitory computer-readable storage medium of claim 11, further comprising instructions executable to identify a first code associated with a first distributor of the identified distributors that promoted the item to the user, the identification based on an evaluation of stored tracking data.

18. The non-transitory computer-readable storage medium of claim 17, further comprising instructions executable to identify a second code associated with a second distributor that the promoted the item to the first distributor.

19. The non-transitory computer-readable storage medium of claim 18, further comprising instructions executable to identify a third code associated with a third distributor that promoted the item to the second distributor.

20. The non-transitory computer-readable storage medium of claim 11, further comprising instructions executable to:
identify a number of items purchased by the user;
identify a number of items returned by the user;
identify that the number of items purchased by the user divided by the number of items returned by the user corresponds to a percentage that at least meets a threshold level; and
block the user from purchasing items associated with the MLM organization based on the percentage at least meeting the threshold level.
